(19) United States
(12) Patent Application Publication
(10) Pub. No.: US 2009/0140989 A1
(43) Pub. Date: Jun. 4, 2009

(54) User interface

(75) Inventor: Pentti Ahlgren, Helsinki (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/999,278

(22) Filed: Dec. 4, 2007

(51) Int. Cl. G06F 3/041

(52) U.S. Cl. 345/173; 341/20

(57) ABSTRACT

The invention relates to a user interface for controlling an electronic device. The user interface includes a sensor element that has a sensor surface and is arranged to form a location indicator that indicates a location of a spot of the sensor surface that is closest to an external object. A force sensor is arranged to form a force indicator that indicates strength of a force directed to the sensor surface. A processor unit is arranged to control the electronic device on the basis of the location indicator and the force indicator. A user of the electronic device is enabled to control the electronic device by using different levels of the force directed to the sensor surface. Therefore, the electronic device can be controlled with a smaller number of repetitive pressing and release actions.

### FIELD OF THE INVENTION

The invention relates to a user interface for controlling an electronic device. The invention further relates to a method and a computer program for controlling an electronic device.

### BACKGROUND

Electronic devices such as mobile communication terminals and palmtop computers are typically equipped with digital devices capable of supporting various services and application functions. As a consequence, designing user interfaces for electronic devices of the kind mentioned above presents unique challenges in view of limited size, a limited number of controls that can be accommodated on such devices, and a need for quick, simple, and intuitive device operation. Especially in conjunction with mobile devices the challenge related to a user interface is exacerbated because such devices are designed to be small, lightweight and easily portable. Consequently, mobile devices typically have limited display screens, keypads, keyboards and/or other input and output devices. Due to the size of the input and output devices, it may be difficult for users to enter, retrieve and view information using mobile devices. Users may have difficulty in accessing desired information, a desired service, and/or a desired application function due to variety of information that may be contained in or accessed with the mobile device, as well as due to a growing number of services and applications functions such devices are capable of supporting. Due to a great number of services and application functions a user interface of an electronic device typically includes a hierarchical menu structure.

A typical user interface of an electronic device according to the prior art includes a hierarchical menu structure in which one or more menu layers are being directly accessible at a time. The user interface can comprise a touch sensitive display screen such that a user of the electronic device is enabled to accomplish control actions by touching icons, texts, or other symbols displayed on the touch sensitive display screen. Due to the limited size of the touch sensitive display screen all details of the menu structure cannot usually be displayed simultaneously. Therefore, the user has usually to perform many successive control actions in order to get to a desired menu item that can be e.g. a desired application function to be performed. Each control action may include pressing a relevant spot of the touch sensitive display screen and, after getting response to the pressing, releasing the above-mentioned spot of the touch sensitive display screen from pressure. The repetitive pressing and release actions make the use of the user interface physically tiring.

### SUMMARY

In accordance with a first aspect of the invention a novel user interface is provided. The user interface comprises:
a sensor element having a sensor surface and being arranged to form a location indicator that is adapted to indicate a location of a spot of the sensor surface that is closest to an external object,
a force sensor equipment arranged to form a force indicator that is adapted to indicate strength of a force directed to the sensor surface, and
a processor unit capable of controlling an electronic device on the basis of said location indicator and said force indicator.

A user of the electronic device is enabled to control the electronic device by using different levels of the force directed to the sensor surface. Therefore, the electronic device can be controlled with a smaller number of repetitive pressing and release actions.

In accordance with a second aspect of the invention a novel method that can be used for controlling an electronic device is provided. The method comprises:
forming a location indicator that indicates a location of a spot of a sensor surface that is closest to an external object,
forming a force indicator that indicates strength of a force directed to the sensor surface, and
controlling an electronic device on the basis of said location indicator and said force indicator.

In accordance with a third aspect of the invention a novel electronic device is provided. The electronic device comprises:
a sensor element having a sensor surface and being arranged to form a location indicator that is adapted to indicate a location of a spot of the sensor surface that is closest to an external object,
a force sensor equipment arranged to form a force indicator that is adapted to indicate strength of a force directed to the sensor surface, and
a processor unit arranged to control the electronic device on the basis of said location indicator and said force indicator.

The electronic device can be, for example, a mobile communication terminal, a palmtop computer, a portable play station, or a combination of them.

In accordance with a fourth aspect of the invention a novel computer program is provided. The computer program comprises computer executable instructions for making a processor unit to control an electronic device on the basis of:
a location indicator that is adapted to indicate a location of a spot of a sensor surface that is closest to an external object, and
a force indicator that is adapted to indicate strength of a force directed to the sensor surface.

A computer readable medium can be encoded with the above-mentioned computer executable instructions.

In accordance with a fifth aspect of the invention a novel interface module is provided. The interface module comprises:
a sensor element having a sensor surface and being arranged to form a location indicator that is adapted to indicate a location of a spot of the sensor surface that is closest to an external object,
a force sensor equipment arranged to form a force indicator that is adapted to indicate strength of a force directed to the sensor surface, and
a processor unit capable of controlling an electronic device connected to the interface module on the basis of said location indicator and said force indicator.

A number of embodiments of the invention are described in accompanied dependent claims.

Various embodiments of the invention both as to constructions and to methods of operation, together with additional objects and advantages thereof, will be best understood from the following description of specific embodiments when read in connection with the accompanying drawings.

The embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### BRIEF DESCRIPTION OF THE FIGURES

The embodiments of the invention that are presented in the sense of examples and their advantages are explained in greater detail below with reference to the accompanying drawings, in which:

FIGS. 1a and 1b show an electronic device comprising a user interface according to an embodiment of the invention,

FIGS. 2a and 2b show an electronic device comprising a user interface according to an embodiment of the invention,

FIGS. 3a and 3b show an electronic device according to an embodiment of the invention,

FIG. 4 is a flow chart of a method according to an embodiment of the invention, and

FIG. 5 shows an interface module according to an embodiment of the invention.

### DESCRIPTION OF THE EMBODIMENTS

A user interface according to an embodiment of the invention comprises: (i) means for forming a location indicator that indicates a location of a spot of a sensor surface that is closest to an external object, (ii) means for forming a force indicator that indicates strength of a force directed to the sensor surface, and (iii) means for controlling an electronic device on the basis of said location indicator and said force indicator.

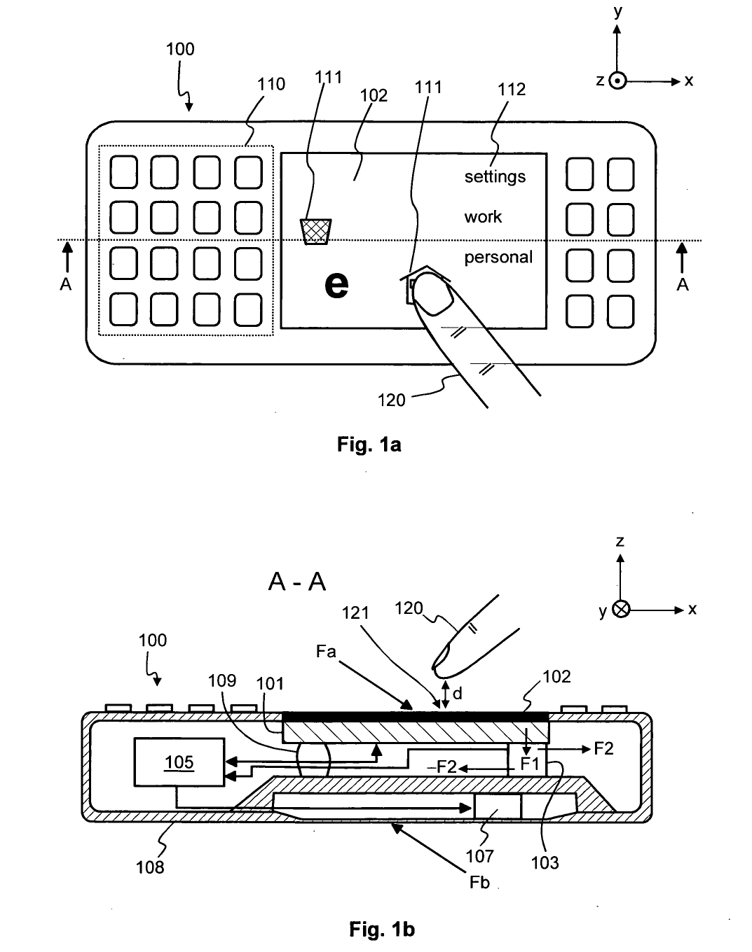

FIG. 1a shows an electronic device 100 comprising a user interface according to an embodiment of the invention. FIG. 1b shows the A-A section view of the electronic device. The user interface of the electronic device comprises a sensor element 101 that has a sensor surface 102. The sensor element is arranged to form a location indicator that is adapted to indicate a location of a spot 121 of the sensor surface 102 that is closest to an external object. The location indicator is an output signal of the sensor element 101. The location indicator can express, for example, x- and y-coordinates of the spot 121. In the exemplifying situation shown in FIGS. 1a and 1b the external object is a finger 120 of a user of the electronic device 100. The user interface comprises a force sensor equipment arranged to form a force indicator that is adapted to indicate strength of a force directed to the sensor surface 102. The force sensor equipment comprises a force sensor 103 that is arranged to detect a pressing force F1 in the z-direction. The force sensor 103 can be arranged to detect also a magnitude of a sheer force F2, −F2 that is in the xy-plane. The force sensor 103 can be arranged to detect also a direction of the sheer force in the xy-plane. The force indicator is an output signal of the force sensor 103. The sensor element 101 can be mechanically supported to the casing of the electronic device for example with the aid of the force sensor 103 and flexible support elements 109. The user interface comprises a processor unit 105 that is capable of controlling the electronic device on the basis of the location indicator and the force indicator. The user interface can comprise a vibration generator 107 responsive to the force indicator and/or to the location indicator. Mechanical vibration generated with the vibration generator can be used e.g. for indicating that the electronic device has received a control action from the user.

In the electronic device shown in FIGS. 1a and 1b, the sensor surface 102 is also a display screen with the aid of which visual information can be shown. It is also possible that a display screen is only a part of the sensor surface 102 or the sensor surface 102 is only a part of a display screen. The user interface of the electronic device can comprise also a keyboard 110 and/or other means for exchanging information between the electronic device and the user.

In a user interface according to an embodiment of the invention the sensor surface 102 is a touch sensitive sensor surface that is arranged to form the location indicator as a response to a situation in which the external object 120 touches the sensor surface.

In a user interface according to an embodiment of the invention the sensor surface 102 is a capacitive sensor surface that is arranged to form the location indicator as a response to a situation in which the distance d between the sensor surface and the external object 120 is less than a pre-determined limit value.

In a user interface according to an embodiment of the invention the sensor surface 102 is a combined touch sensitive and capacitive sensor surface.

In a user interface according to an embodiment of the invention the force sensor 103 is arranged to detect the magnitude of the sheer force F2, −F2. A magnitude of a twisting effect caused by a force Fa directed to the sensor surface 102 and by a force Fb directed to another surface 108 of the electronic device than the sensor surface is indicated by the magnitude of the sheer force F2, −F2. The processor unit 105 is capable of controlling the electronic device on the basis of the magnitude of the twisting effect.

In a user interface according to an embodiment of the invention the force sensor 103 is arranged to detect the direction of the sheer force F2, −F2 in the xy-plane. A direction of the twisting effect caused by the forces Fa and Fb is indicated by the direction of the sheer force F2, −F2 in the xy-plane. The processor unit 105 is capable of controlling the electronic device on the basis of the direction of the twisting effect.

In a user interface according to an embodiment of the invention the processor unit 105 is capable of controlling the electronic device on the basis of both the direction and the magnitude of the twisting effect.

In a user interface according to an embodiment of the invention the processor unit 105 is arranged to highlight a symbol displayed on the sensor surface as a response to a situation in which the distance d between the external object 120 and the symbol is less than a pre-determined limit value. The symbol can be, for example, an icon 111, a piece of text 112, or some other kind of piece of visual information shown on the sensor surface.

In a user interface according to an embodiment of the invention the processor unit 105 is arranged to select the symbol 111 and to modify visual information displayed on the sensor surface 102 around the symbol as a response to a situation in which the external object 120 is touching the sensor surface in a location in which the symbol 111 is being displayed.

In a user interface according to an embodiment of the invention the processor unit 105 is capable of controlling the electronic device to execute a function related to the symbol 111 as a response to a situation in which the strength of the force directed to the sensor surface exceeds a pre-determined limit value and the force is directed to the sensor surface in the location in which the symbol is being displayed.

In a user interface according to an embodiment of the invention the processor unit 105 is arranged to change the symbol 111 displayed on the sensor surface from a non-selected state to a selected-to-move state and to move a position of the symbol on the sensor surface 102 as a response to a situation in which the external object 120 is touching the sensor surface in a location in which the symbol is being displayed and the external object is being moved on the sensor surface. The symbol is moved along with the external object. After moving, the symbol can be returned back to the non-selected state as a response to e.g. a situation in which the sensor surface is no more pressed.

In a user interface according to an embodiment of the invention the force sensor equipment comprises an acceleration sensor. The processor unit 105 is arranged to perform a control action, for example to change the symbol from the selected-to-move state to the non-selected state, as a response to a situation in which the acceleration is detected to exceed a pre-determined limit e.g. when the electronic device is shaken.

In a user interface according to an embodiment of the invention the processor unit 105 is arranged to modify visual information shown on the sensor surface 102 as a response to a situation in which the force directed to the sensor surface exceeds a pre-determined limit. The modification of the visual information can be used as a feedback from the electronic device to the user, said feedback indicating that the device has received a control action from the user.

A user interface according to an embodiment of the invention comprises a vibration generator 107 that is arranged to produce mechanical vibration. The processor unit 105 is arranged to activate the vibration generator to produce mechanical vibration as a response to a situation in which the force directed to the sensor surface exceeds a pre-determined limit. The mechanical vibration can be used as a feedback from the electronic device to the user, said feedback indicating that the device has received a control action from the user.

In a user interface according to an embodiment of the invention the processor unit 105 is arranged to modify visual information shown on the sensor surface 102 as a response to a situation in which the force directed to the sensor surface exceeds a first pre-determined limit and to activate the vibration generator 107 to produce mechanical vibration as a response to a situation in which the force directed to the sensor surface exceeds a second pre-determined limit. The user of the electronic device can get different feedbacks corresponding to different levels of the force.

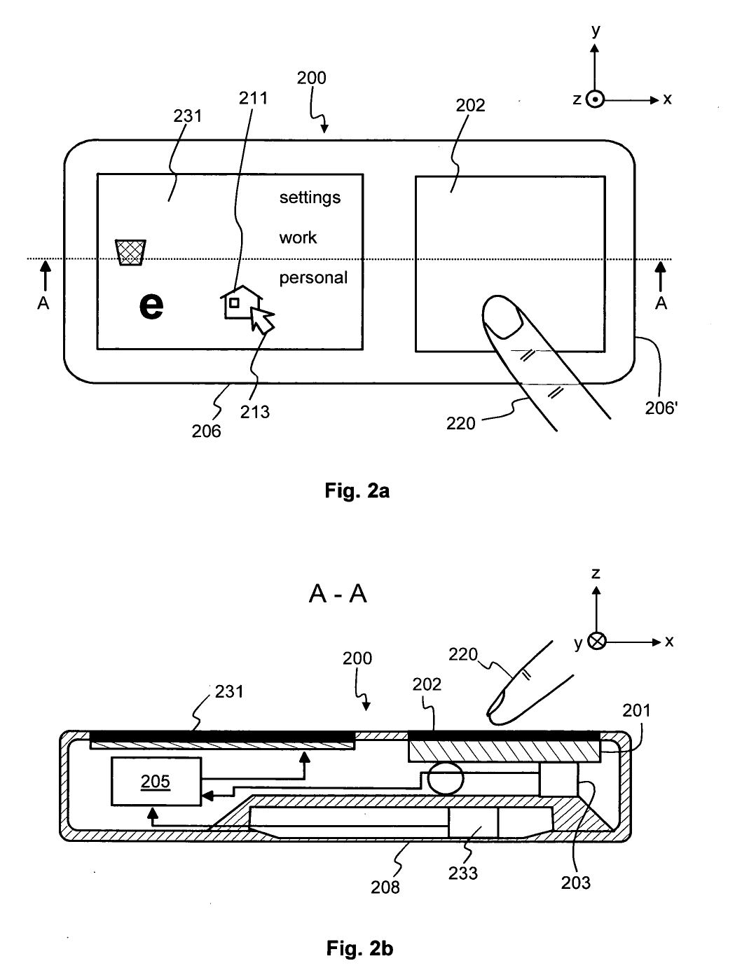

FIG. 2a shows an electronic device 200 comprising a user interface according to an embodiment of the invention. FIG. 2b shows the A-A section view of the electronic device. The user interface of the electronic device comprises a sensor element 201 that has a sensor surface 202. The sensor element is arranged to form a location indicator that is adapted to indicate a location of a spot of the sensor surface that is closest to an external object 220. The location indicator can express, for example, x- and y-coordinates of the spot closest to the external object. The sensor surface can be a touch sensitive sensor surface, a capacitive sensor surface, or a combined capacitive and touch sensitive sensor surface. The user interface comprises a force sensor equipment arranged to form a first force indicator that is adapted to indicate strength of a force directed to the sensor surface and a second (another) force indicator arranged to indicate a temporal change of a force directed to another surface of the electronic device than the sensor surface 202. The force sensor equipment comprises a force sensor 203 that is arranged to detect the force directed to the sensor surface, and a force sensor 233 that is arranged to detect a temporal change of the force directed to the other surface 208 of the electronic device. In the embodiment of the invention shown in FIGS. 2a and 2b, the above-mentioned other surface of the electronic device is the surface on the opposite side of the electronic device with respect to the sensor surface. The other surface could as well be a side surface 206 of the electronic device or a butt-end surface 206′ of the electronic device. The user interface comprises a processor unit 205 that is capable of controlling the electronic device on the basis of the location indicator, the first force indicator, and the second force indicator. The user interface comprises a display screen 231 with the aid of which visual information can be shown.

In a user interface according to an embodiment of the invention the sensor surface 202 is a capacitive sensor surface and the processor unit 205 is arranged to move a cursor 213 on the display screen as a response to a situation in which a distance between the external object 220 and the sensor surface is less than a pre-determined limit value and the external object is moved in the xy-plane. The cursor is moved on the display screen according to movements of the external object in the xy-plane. The processor unit 205 is arranged to highlight a symbol 211 displayed on the display screen as a response to a situation in which the external object 220 touches the sensor surface and the cursor 213 is pointing to the symbol. In other words, a symbol pointed to by the cursor can be selected for further actions by touching the sensor screen. The processor unit 205 is arranged to move the symbol 211 on the display screen as a response to a situation in which the external object touches the sensor surface, the cursor 213 is pointing to the symbol, and the external object is moved on the sensor surface. The processor unit 205 is capable of controlling the electronic device to execute a function related to the symbol 211 as a response to a situation in which the strength of the force directed to the sensor surface exceeds a pre-determined limit value (e.g. 0.3 N) and the cursor 213 is pointing to the symbol.

In a user interface according to an embodiment of the invention the sensor surface 202 is a touch sensitive sensor surface and the processor unit 205 is arranged to move a cursor 213 on the display screen as a response to a situation in which the external object 220 touches the sensor surface and the external object is moved on the sensor surface. The cursor is moved on the display screen according to movements of the external object on the sensor surface. The processor unit 205 is arranged to highlight a symbol 211 displayed on the display screen as a response to a situation in which the strength of the force directed to the sensor surface exceeds a first pre-determined limit value (e.g. 0.3 N) and the cursor 213 is pointing to the symbol. In other words, a symbol pointed to by the cursor can be selected for further actions by pressing the sensor screen with a force greater than the first pre-determined limit value. The processor unit 205 is arranged to move the symbol 211 on the display screen as a response to a situation in which the strength of the force directed to the sensor surface exceeds the first pre-determined limit value, the cursor 213 is pointing to the symbol, and the external object is moved on the sensor surface. The processor unit 205 is arranged to control the electronic device to execute a function related to the symbol 211 as a response to a situation in which the strength of the force directed to the sensor surface exceeds a second pre-determined limit value (e.g. 3 N) and the cursor 213 is pointing to the symbol.

In a user interface according to an embodiment of the invention the processor unit 205 is capable of controlling the electronic device to perform a pre-determined action as a response to a situation in which a temporal change of the force directed to the surface 208 of the electronic device is detected. The temporal change of the force can be detected with the force sensor 233.

In a user interface according to an embodiment of the invention the processor unit 205 is capable of controlling the electronic device to execute a function related to the symbol 211 as a response to a situation in which a temporal change of the force directed to the surface 208 of the electronic device is detected and the cursor 213 is pointing to the symbol.

In a user interface according to an embodiment of the invention the processor unit 205 is arranged to modify an image shown on the display screen as a response to a situation in which the force directed to the surface 208 of the electronic device exceeds a pre-determined limit value. The modification of the image can comprise e.g. zooming of the said image in or out as long as the above-mentioned force exceeds the pre-determined limit value.

An electronic device according to an embodiment of the invention comprises: (i) means for forming a location indicator that indicates a location of a spot of a sensor surface that is closest to an external object, (ii) means for forming a force indicator that indicates strength of a force directed to the sensor surface, and (iii) means for controlling the electronic device on the basis of the location indicator and the force indicator.

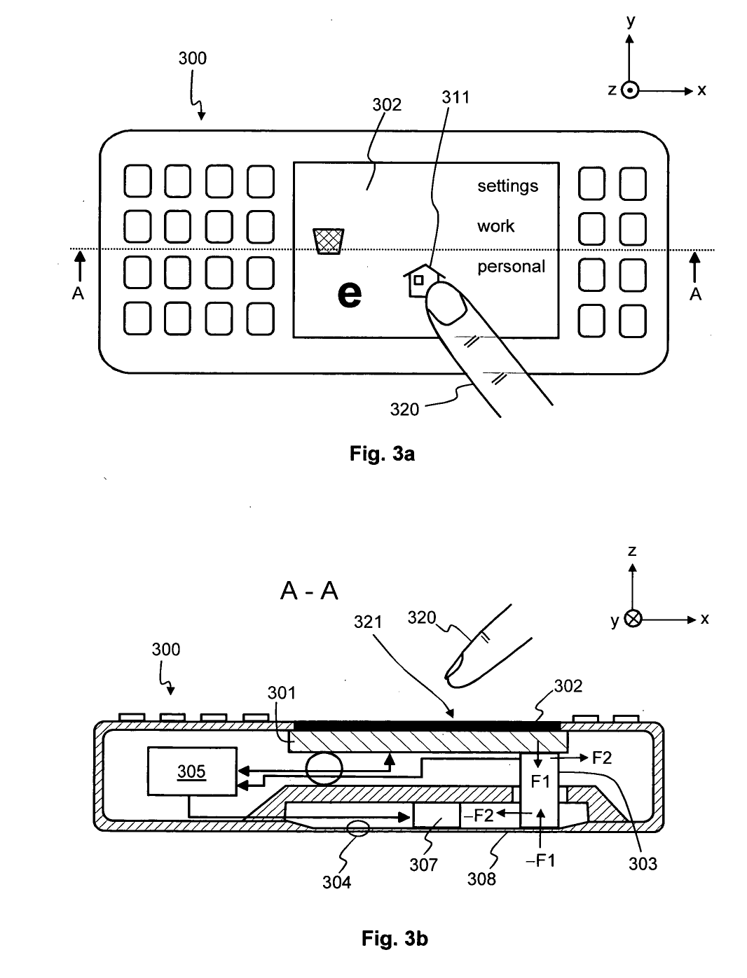

FIG. 3a shows an electronic device 300 according to an embodiment of the invention. FIG. 3b shows the A-A section view of the electronic device. The electronic device can be a mobile communication terminal, a palmtop computer, a portable play station, or a combination of them. The electronic device comprises a sensor element 301 that has a sensor surface 302. The sensor element is arranged to form a location indicator that is adapted to indicate a location of a spot 321 of the sensor surface that is closest to an external object 320. The location indicator can express, for example, x- and y-coordinates of the spot closest to the external object. The sensor surface can be a touch sensitive sensor surface, a capacitive sensor surface, or a combined capacitive and touch sensitive sensor surface. The electronic device comprises a force sensor equipment arranged to form a force indicator that is adapted to indicate strength of a force directed to the sensor surface. The force sensor equipment comprises a force sensor 303 that is arranged to detect the force directed to the sensor surface. In the electronic device shown in FIGS. 3a and 3b, the force sensor 303 is mounted between the sensor element 301 and a wall 304 of the housing of the electronic device in such a way that the force sensor 303 can be used for detecting also a force directed to a surface 308 of the electronic device. The force sensor 303 can be capable of detecting also a magnitude and/or a direction of a sheer force F2, −F2 that is in the xy-plane. The electronic device comprises a processor unit 305 arranged to control the electronic device on the basis of the location indicator and the force indicator. The sensor surface 302 is also a display screen with the aid of which visual information can be shown. The electronic device can comprise a vibration generator 307 responsive to the force indicator and/or to the location indicator. Mechanical vibration generated with the vibration generator can be used e.g. for indicating that the electronic device has received a control action from a user of the electronic device.

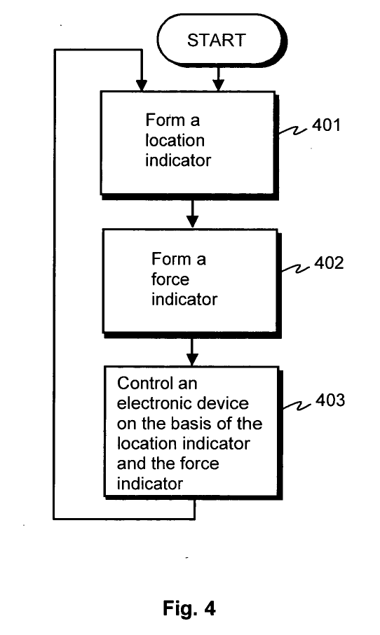

FIG. 4 is a flow chart of a method according to an embodiment of the invention for controlling an electronic device. Phase 401 comprises forming a location indicator that indicates a location of a spot of a sensor surface that is closest to an external object. Phase 402 comprises forming a force indicator that indicates strength of a force directed to the sensor surface. Phase 403 comprises controlling the electronic device on the basis of the location indicator and the force indicator. The external object can be e.g. a finger of a user of the electronic device.

In a method according to an embodiment of the invention another force indicator that indicates a temporal change of a force directed to another surface of the electronic device than the sensor surface is formed and the electronic device is controlled on the basis of the location indicator, the force indicator, and the other force indicator.

In a method according to an embodiment of the invention at least a part of the sensor surface is capable of operating as a display screen and visual information is displayed on that part the sensor surface.

In a method according to an embodiment of the invention the electronic device is controlled to highlight a symbol displayed on the sensor surface as a response to a situation in which a distance between the external object and the symbol is less than a pre-determined limit value.

In a method according to an embodiment of the invention the electronic device is controlled to select the symbol and to modify visual information displayed on the sensor surface around the symbol as a response to a situation in which the external object is touching the sensor surface in a location in which the symbol is being displayed.

In a method according to an embodiment of the invention the electronic device is controlled to execute a function related to the symbol as a response to a situation in which the strength the force directed to the sensor surface exceeds a pre-determined limit value and the force is directed to the sensor surface in the location in which the symbol is being displayed.

In a method according to an embodiment of the invention the electronic device is controlled to change a symbol displayed on the sensor surface from a non-selected state to a selected-to-move state and to move a position of the symbol on the sensor surface as a response to a situation in which the external object is pressing the sensor surface in a location in which the symbol is being displayed and the external object is being moved on the sensor surface. The symbol is moved along with the external object.

In a method according to an embodiment of the invention the electronic device is controlled to change the symbol from the selected-to-move state to the non-selected state as a response to a situation in which a temporal change in a force directed to another surface of the electronic device than the sensor surface is detected.

In a method according to an embodiment of the invention the electronic device is controlled to perform an action, e.g. to change the symbol from the selected-to-move state to the non-selected state, as a response to a situation in which acceleration of the electronic device is detected to exceed a pre-determined limit.

In a method according to an embodiment of the invention the electronic device is controlled to produce mechanical vibration as a response to a situation in which the force directed to the sensor surface exceeds a pre-determined limit.

A computer program according to an embodiment of the invention comprises computer executable instructions for making a processor unit to control an electronic device on the basis of:
a location indicator that is adapted to indicate a location of a spot of a sensor surface that is closest to an external object, and
a force indicator that is adapted to indicate strength of a force directed to the sensor surface.

The processor unit in which the computer program can be executed can be e.g. the processor unit 305 of the electronic device 300 shown in FIG. 3.

The computer program means can be, for example, sub-routines and/or functions.

A computer program according to an embodiment of the invention comprises computer executable instructions for making the processor unit to control the electronic device on the basis of the location indicator, the force indicator, and another force indicator that is arranged to indicate a temporal change of a force directed to another surface of the electronic device than the sensor surface.

A computer program according to an embodiment of the invention can be stored in a computer readable medium. The computer readable medium can be, for example, an optical compact disk or an electronic memory device like a RAM (random access memory) or a ROM (read only memory).

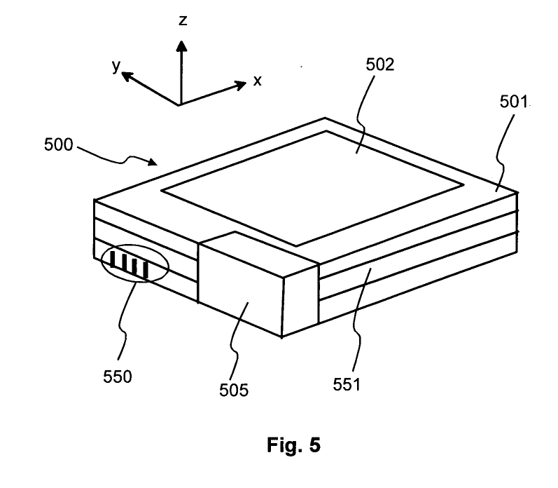

FIG. 5 shows an interface module 500 according to an embodiment of the invention. The interface module can be used as a building block of an electronic device that can be e.g. a mobile phone. The interface module comprises a sensor element 501 that has a sensor surface 502. The sensor element is arranged to form a location indicator that is adapted to indicate a location of a spot of the sensor surface that is closest to an external object. The interface module comprises a force sensor equipment arranged to form a force indicator that is adapted to indicate strength of a force directed to the sensor surface. The force sensor equipment comprises one or more force sensors that are located in a layer 551 and are arranged to measure the strength of the force directed to the sensor surface. The force sensors can be arranged to measure a magnitude of a pressing force that is in the z-direction. The force sensors can be also capable of measuring a magnitude of a sheer force that is in the xy-plane. The force sensors can be also capable of measuring a direction of the sheer force in the xy-plane. The interface module comprises a processor unit 505 that is capable of controlling an electronic device connected to the interface module on the basis of the location indicator and the force indicator. The interface module comprises connector pads 550 via which electrical signals can be conducted to/from the interface module.

In an interface module according to an embodiment of the invention the force sensor equipment is arranged to form another force indicator arranged to indicate a temporal change of a force directed to another surface of the interface module than the sensor surface. The processor unit 505 is capable of controlling an electronic device connected to the interface module on the basis of the location indicator, the force indicator, and the other force indicator.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. The specific examples provided in the description given above should not be construed as limiting. Therefore, the invention is not limited merely to the embodiments described above, many variants being possible without departing from the scope of the inventive idea.

What is claimed is:

1. A user interface comprising:
a sensor element having a sensor surface and being arranged to form a location indicator that is adapted to indicate a location of a spot of the sensor surface that is closest to an external object,
a force sensor equipment arranged to form a force indicator that is adapted to indicate strength of a force directed to the sensor surface, and
a processor unit capable of controlling an electronic device on the basis of said location indicator and said force indicator.

2. A user interface according to claim 1, wherein the sensor surface is a touch sensitive sensor surface arranged to form said location indicator as a response to a situation in which the external object is touching the sensor surface.

3. A user interface according to claim 1, wherein the sensor surface is a capacitive sensor surface arranged to form said location indicator as a response to a situation in which a distance between the sensor surface and the external object is less than a pre-determined limit value.

4. A user interface according to claim 1, wherein said force sensor equipment is arranged to form another force indicator that is adapted to indicate a temporal change of a force directed to another surface of the electronic device than the sensor surface and the processor unit is capable of controlling the electronic device on the basis of the other force indicator.

5. A user interface according to claim 1, wherein said force sensor equipment is arranged to detect a twisting effect caused by the force directed to the sensor surface and by a force directed to another surface of the electronic device than the sensor surface and the processor unit is capable of controlling the electronic device on the basis of the twisting effect.

6. A user interface according to claim 1, wherein user interface comprises a display screen.

7. A user interface according to claim 6, wherein the display screen is one of the following: the sensor surface and a part of the sensor surface.

8. A user interface according to claim 7, wherein the processor unit is arranged to highlight a symbol displayed on the sensor surface as a response to a situation in which a distance between the external object and the symbol is less than a pre-determined limit value.

9. A user interface according to claim 8, wherein the processor unit is arranged to select the symbol and to modify visual information displayed on the sensor surface around the symbol as a response to a situation in which the external object is touching the sensor surface in a location in which the symbol is being displayed.

10. A user interface according to claim 9, wherein the processor unit is capable of controlling the electronic device to execute a function related to the symbol as a response to a situation in which the strength the force directed to the sensor surface exceeds a pre-determined limit value and the force is directed to the sensor surface in the location in which the symbol is being displayed.

11. A user interface according to claim 7, wherein the processor unit is arranged to change a symbol displayed on the sensor surface from a non-selected state to a selected-to-move state and to move a position of the symbol on the sensor surface as a response to a situation in which the external object is pressing the sensor surface in a location in which the symbol is being displayed and the external object is being moved on the sensor surface, the symbol being moved along with the external object.

12. A user interface according to claim 11, wherein said force sensor equipment is arranged to detect a temporal change of a force directed to another surface of the electronic device than the sensor surface and the processor unit is arranged to change the symbol from the selected-to-move state to the non-selected state as a response to a detection of the temporal change of the force directed to the other surface of the electronic device.

13. A user interface according to claim 1, wherein said force sensor equipment comprises an acceleration sensor and the processor unit is arranged to perform a control action as a response to a situation in which acceleration is detected to exceed a pre-determined limit.

14. A user interface according to claim 1, wherein the user interface comprises a vibration generator arranged produce mechanical vibration and the processor unit is arranged to activate the vibration generator as a response to a situation in which the force directed to the sensor surface exceeds a pre-determined limit.

15. A method comprising:
forming a location indicator that indicates a location of a spot of a sensor surface that is closest to an external object,
forming a force indicator that indicates strength of a force directed to the sensor surface, and
controlling an electronic device on the basis of said location indicator and said force indicator.

16. A method according to claim 15, wherein another force indicator that indicates a temporal change of a force directed to another surface of the electronic device than the sensor surface is formed and the electronic device is controlled on the basis of said other force indicator.

17. A method according to claim 15, wherein at least a part of the sensor surface is capable of operating as a display screen and visual information is displayed on the sensor surface.

18. A method according to claim 17, wherein the electronic device is controlled to highlight a symbol displayed on the sensor surface as a response to a situation in which a distance between the external object and the symbol is less than a pre-determined limit value.

19. A method according to claim 18, wherein the electronic device is controlled to select the symbol and to modify visual information displayed on the sensor surface around the symbol as a response to a situation in which the external object is touching the sensor surface in a location in which the symbol is being displayed.

20. A method according to claim 19, wherein the electronic device is controlled to execute a function related to the symbol as a response to a situation in which the strength the force directed to the sensor surface exceeds a pre-determined limit value and the force is directed to the sensor surface in the location in which the symbol is being displayed.

21. A method according to claim 17, wherein the electronic device is controlled to change a symbol displayed on the sensor surface from a non-selected state to a selected-to-move state and to move a position of the symbol on the sensor surface as a response to a situation in which the external object is pressing the sensor surface in a location in which the symbol is being displayed and the external object is being moved on the sensor surface, the symbol being moved along with the external object.

22. A method according to claim 21, wherein the electronic device is controlled to change the symbol from the selected-to-move state to the non-selected state as a response to a situation in which a temporal change in a force directed to another surface of the electronic device than the sensor surface is detected.

23. A method according to claim 21, wherein the electronic device is controlled to perform an action as a response to a situation in which acceleration of the electronic device is detected to exceed a pre-determined limit.

24. A method according to claim 15, wherein the electronic device is controlled to produce mechanical vibration as a response to a situation in which the force directed to the sensor surface exceeds a pre-determined limit.

25. A method according to claim 15, wherein a twisting effect caused by the force directed to the sensor surface and by a force directed to another surface of the electronic device than the sensor surface is detected and the electronic device is controlled on the basis of the twisting effect.

26. An electronic device comprising:
a sensor element having a sensor surface and being arranged to form a location indicator that is adapted to indicate a location of a spot of the sensor surface that is closest to an external object,
a force sensor equipment arranged to form a force indicator that is adapted to indicate strength of a force directed to the sensor surface, and
a processor unit arranged to control the electronic device on the basis of said location indicator and said force indicator.

27. An electronic device according to claim 26, wherein said force sensor equipment is arranged to form another force indicator that is adapted to indicate a temporal change of a force directed to another surface of the electronic device than the sensor surface and the processor unit is arranged to control the electronic device on the basis of the other force indicator.

28. An electronic device according to claim 26, wherein the electronic device is at least one of the following: a mobile communication terminal, a palmtop computer, and a portable play station.

29. An electronic device according to claim 26, wherein the electronic device comprises at least one of the following: a vibration generator responsive to said force indicator and a display screen responsive to said force indicator.

30. A computer readable medium encoded with computer executable instructions for making a processor unit to control an electronic device on the basis of:
a location indicator that is adapted to indicate a location of a spot of a sensor surface that is closest to an external object, and
a force indicator that is adapted to indicate strength of a force directed to the sensor surface.

31. A computer readable medium according to claim 30, wherein the computer readable medium is encoded with computer executable instructions for making the processor unit to control the electronic device on the basis of another force indicator that is arranged to indicate a temporal change of a force directed to another surface of the electronic device than the sensor surface.

32. An interface module comprising:
a sensor element having a sensor surface and being arranged to form a location indicator that is adapted to indicate a location of a spot of the sensor surface that is closest to an external object,
a force sensor equipment arranged to form a force indicator that is adapted to indicate strength of a force directed to the sensor surface, and
a processor unit capable of controlling an electronic device connected to the interface module on the basis of said location indicator and said force indicator.

33. An interface module according to claim 32, wherein said force sensor equipment is arranged to form another force indicator that is adapted to indicate a temporal change of a force directed to another surface of the interface module than the sensor surface and the processor unit is capable of controlling the electronic device on the basis of the other force indicator.

34. A user interface comprising:
means for forming a location indicator that indicates a location of a spot of a sensor surface that is closest to an external object,
means for forming a force indicator that indicates strength of a force directed to the sensor surface, and
means for controlling an electronic device on the basis of said location indicator and said force indicator.
